(19) United States
(12) Patent Application Publication
(10) Pub. No.: US 2024/0039766 A1
(43) Pub. Date: Feb. 1, 2024

(54) AN APPARATUS, A METHOD, AND A NON-TRANSITORY COMPUTER READABLE MEDIUM FOR DETERMINING A RANDOM ACCESS PREAMBLE IDENTIFIER

(71) Applicant: Nokia Solutions and Networks Oy, Espoo (FI)

(72) Inventors: Gerhard Schreiber, Korntal-Münchingen (DE); Jafar Mohammadi, Stuttgart (DE); Thorsten Wild, Stuttgart (DE)

(73) Assignee: Nokia Solutions and Networks Oy, Espoo (FI)

(21) Appl. No.: 18/555,521

(22) PCT Filed: Apr. 16, 2021
(86) PCT No.: PCT/EP2021/059927

§ 371 Date: Oct. 14, 2023

(51) Int. Cl. H04L 25/02

(52) U.S. Cl. CPC H04L 25/021; H04L 25/0254

(57) ABSTRACT

An apparatus, comprising at least one processor and at least one memory storing instructions, the at least one memory and the instructions configured to, with the at least one processor, cause a receiver to perform a correlation processing of a first signal received by the receiver and/or of a second signal which can be derived from the first signal, and to at least temporarily modify an output signal of the correlation processing using at least one neural network, wherein a modified output signal may be obtained.

### FIELD OF THE DISCLOSURE

Various example embodiments relate to an apparatus comprising at least one processor.

Further embodiments relate to a method of operating related to such apparatus.

### BACKGROUND

Wireless communications systems may e.g. be used for wireless exchange of information between two or more entities, e.g. comprising one or more terminal devices, e.g. user equipment (UE), and one or more network devices such as e.g. base stations (e.g., gNB), the base stations e.g. providing radio cells for serving terminal devices such as the UE.

In some wireless communications systems, a random access procedure may be performed, wherein a preamble sequence is to be detected. A purpose of some random access procedures may be to establish timing synchronization between a UE and a gNB, and to obtain resources e.g. for dedicated uplink scheduling requests. Random access procedure in wireless communication systems like 5G NR may occur in various contexts: initial access, handover, reestablish uplink synchronization upon loss, beam failure recovery, on-demand system-information requests.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to an apparatus, comprising at least one processor, and at least one memory storing instructions, the at least one memory and the instructions configured to, with the at least one processor, cause a receiver to perform a correlation processing of a first signal received by the receiver and/or of a second signal which can be derived from the first signal, and to at least temporarily modify an output signal of the correlation processing using at least one neural network, wherein a modified output signal may be obtained.

In some embodiments, at least temporarily modifying an output signal of the correlation processing using at least one neural network may enable to improve signal to noise ratio (SNR) values, e.g. by providing a coherent combining of input signals, which may be beneficial for a detection of a physical random access channel, PRACH.

Thus, in some embodiments, a coherent combining of input signals may be performed.

In some embodiments, the coherent combining may be enabled by the at least one neural network learning channel coefficients of a radio channel associated with the first signal and using the learned, e.g. trained, channel coefficients for enabling coherent combining.

In other words, in some embodiments, conventional, e.g. PRACH, detection schemes may be enhanced by exemplary embodiments, e.g. by adding machine-learning backed coherent antenna combining gains.

In some embodiments, a procedure to obtain the gains may comprise at least one neural-network (NN), e.g. an artificial neural network (ANN), e.g. a deep neural network (DNN), which may learn channel coefficients associated with a radio channel over which the received signal has been transmitted and which may use the learned channel coefficients e.g. to produce a coherent combining of the input signals (e.g., the received signal), e.g. to enhance SNR values, for example at least in some embodiments at least sometimes beyond non-coherent conventional combining approaches.

In some embodiments, the enhanced combining scheme according to some embodiments may be used in situations where an SNR of the received signal is below a predetermined threshold. In some embodiments, for example, when the SNR of the received signal is equal to or greater than the predetermined threshold, another scheme, for example a conventional PRACH detection scheme, may be used.

In some embodiments, the apparatus may be for a receiver, for example for a base station, e.g. a gNodeB (gNB), e.g. for the wireless communications system.

In some embodiments, the apparatus may be integrated in the gNB.

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation), e.g. 5G NR (new radio), or other radio access technology.

In some embodiments, the first signal may comprise a preamble, for example PRACH preamble, of a UE trying to access a radio cell served by the gNB.

In some embodiments, the instructions, when executed by the at least one processor, cause the receiver to determine at least one random access preamble identifier based on at least one of a) the output signal of the correlation processing and b) the modified output signal of the correlation processing. In other words, in some embodiments, at least sometimes, the random access preamble identifier may be detected using both the output signal of the correlation processing and the modified output signal of the correlation processing. In some embodiments, it is also conceivable to at least sometimes detect the random access preamble identifier based on the modified output signal of the correlation processing. In some embodiments, it is also conceivable to at least sometimes detect the random access preamble identifier based on the (non-modified) output signal of the correlation processing.

In some embodiments, the correlation processing may comprise a correlation of the received signal and/or of the signal derived from the received signal, with a physical root sequence which may in some embodiments be configured in a radio cell provided by the gNB. In some embodiments, the correlation. processing may be performed in the frequency domain.

In some embodiments, a correlation processing in the frequency domain may be equivalent to a correlation of a corresponding time domain signal with, for example all, time-domain. cyclic shifted versions of the root sequence.

In some embodiments, an advantage of performing the correlation processing in the frequency domain. is that only one multiplication per physical root is required. In some embodiments, the correlation. processing may be performed and/or repeated for several, e.g. all, physical root sequences, which are e.g. configured in a respective cell.

In some embodiments, the second signal, which can be derived from the first signal, may e.g. be derived from the first signal by using one or more of the following optional aspects A), B), C), D), E):
A) The receiver, e.g. gNB, may receive the first signal at its antennas, the first signal for example comprising a random access preamble transmitted by a UE,
B) the receiver may conduct one or more pre-processing procedures, e.g. prior to preamble detection, such as e.g. down-conversion (e.g., transforming the first signal to a lower frequency range such as a low-pass frequency range or an intermediate frequency range), (e.g. band-pass)-filtering, analog-to-digital conversion,
C) Removal of a preamble cyclic-prefix (CP). In some embodiments, various preamble formats showing different CP are defined in standards, e.g. to support different coverage ranges from few hundreds of meters up to more than 100 kilometers,
D) Coherent combining over symbol repetitions in time domain per antenna. Whether or not coherent combining over repetitions is employed in some embodiments depends on a selected combining strategy.
E) Conversion of the time domain signal, e.g. as obtained according to at least one of the preceding aspects A), B), C), D) into the frequency domain, for example via a FFT (Fast Fourier Transform). The size of a so obtained complex-valued frequency domain signal per antenna has a same size as the sequence length.

In some embodiments, one or more, or all, of the preceding aspects A), B), C), D), E) may be performed, and the frequency domain signal as obtained according to exemplary aspect E) may be used as the second signal, e.g. as an input signal to the correlation processing.

In some embodiments, the instructions, when executed by the at least one processor, cause the receiver to determine a weighted sum of the output signal of the correlation processing and of the modified output signal of the correlation processing, which may increase operational flexibility in some embodiments.

In some embodiments, the instructions, when executed by the at least one processor, cause the receiver to determine a weight factor for determining the weighted sum.

In some embodiments, the instructions, when executed by the at least one processor, cause the receiver to determine the weight factor based on at least one of the following elements: a) a first signal to noise ratio characterizing an estimated signal to noise ratio of the output signal of the correlation processing, b) a second signal to noise ratio for which the weight factor equals 0.5, c) a predetermined slope parameter, which for example characterizes a sensitivity of the weight factor with respect to the first signal to noise ratio.

In some embodiments, the instructions, when executed by the at least one processor, cause the receiver to determine the weight factor based on the equation:

$$α = \frac{1}{1 + {e}^{( {SNR}_{est} - {SNR}_{trans} ) / Slope}} ,$$

wherein α characterizes the weight factor, wherein SNRₑₛₜ characterizes the first signal to noise ratio, wherein SNRₜᵣₐₙₛ characterizes the second signal to noise ratio, wherein Slope characterizes the slope parameter, and wherein e^{(•)} characterizes the exponential function.

In some embodiments, at least temporarily modifying the output signal of the correlation processing comprises: determining a covariance matrix based on the output signal of the correlation processing, determining a first weight matrix based on a real part of the covariance matrix using a first neural network, determining a second weight matrix based on an imaginary part of the covariance matrix using a second neural network, providing the modified output signal based on the output signal of the correlation processing, the first weight matrix, and the second weight matrix.

In some embodiments, using the (real or imaginary part of the) covariance matrix as the input data to the neural network is advantageous, because this may speed up the convergence and may require smaller neural networks to achieve similar combining gain, as compared to approaches with other types of input. Thus, in some embodiments, efficient implementations may be provided.

In some embodiments, providing the modified output signal comprises: providing the modified output signal based on the equation f(z)=X+iY, wherein f(z) characterizes the modified output signal, wherein z characterizes the output signal of the correlation processing, wherein X=Wr·Re(z)−Wi·Im(z), wherein Y=Wr·Im(z)+Wi·Re(z), wherein Wr characterizes the first weight matrix, wherein Wi characterizes the second weight matrix, wherein Re(•) characterizes the real part, and wherein Im(•) characterizes the imaginary part.

In some embodiments, providing the modified output signal is performed for one or more subcarriers and/or one or more root sequences associated with the first signal.

In some embodiments, the at least one neural network comprises two or more, for example four, fully connected layers with a number n of processing elements each, wherein n may depend on a number N of receive antenna ports over which the first signal is received, wherein for example n>N, or n>=N².

In some embodiments, the at least one neural network is configured to modify noise-related statistics of the output signal of the correlation processing.

In some embodiments, at least one of the following exemplary aspects may be used, e.g. based on the modified output signal of the correlation processing, i.e. using the modified output signal of the correlation processing according to some embodiments as input:
a) transforming the modified output signal into the time domain, e.g. for a plurality or all correlated signals,
b) determine, e.g. calculate, a squared norm, e.g. for the, e.g. each, time domain signal(s) as obtained by preceding aspect a),
c) summation of signals, e.g. as obtained by preceding aspect b), e.g. over all receive antennas of the receiver, wherein e.g. one power-delay profile per physical root sequence may be obtained,
d) determine at least one, e.g. all, random access preamble identifier(s) (RAPID) and/or timing advance value(s), e.g. based on the power delay profiles as obtained by preceding aspect c).

Further exemplary embodiments relate to an apparatus comprising means for causing a receiver to perform a correlation processing of a first signal received by the receiver and/or of a second signal which can be derived from the first signal, and to at least temporarily modify an output signal of the correlation processing using at least one neural network, wherein a modified output signal may be obtained. In some embodiments, the means for causing the receiver to e.g. perform the correlation processing may comprise at least one processor, and at least one memory storing instructions, the at least one memory and the instructions configured to, with the at least one processor, cause a receiver to perform the correlation processing and/or other aspects of the method according to the embodiments exemplarily disclosed above.

Some exemplary embodiments relate to a method of operating a receiver, the method comprising: performing a correlation processing of a first signal received by the receiver and/or of a second signal which can be derived from the first signal, and at least temporarily modifying an output signal of the correlation processing using at least one neural network, wherein a modified output signal may be obtained.

Some embodiments relate to a method of training a neural network, e.g. a neural network for an apparatus according to exemplary embodiments, the method comprising: Determining a simulated output signal of a correlation processing of a first signal comprising first samples with noise and second samples without noise, performing supervised training of the neural network using the samples with noise as input for the neural network and the samples without noise as training labels.

In some embodiments, a mean squared error between neural-network processed samples and noise-free samples may be used as optimization criterion, e.g. during a parameter optimization according to some embodiments.

In some embodiments, the at least one neural network is not trained for different logical root indices. Therefore, in some embodiments, for example only samples with a logical root index equal 0 may be used for training.

In some embodiments, training data originating from one of a plurality of sectors of a radio cell in deployment may be used.

In some embodiments, samples used for the training may cover a SNR range between −14 dB and 0 dB, e.g. with a step size of 1 dB. In some embodiments, a number of samples per SNR is around 1.5 million.

Some embodiments relate to a wireless communications system comprising at least one apparatus according to the embodiments.

Some embodiments relate to a non-transitory computer readable medium comprising program instructions for causing an apparatus to perform at least the method according to the embodiments.

### BRIEF DESCRIPTION OF THE FIGURES

FIG. 1 schematically depicts a simplified block diagram of an apparatus according to some embodiments,

FIG. 2 schematically depicts a simplified block diagram according to some embodiments,

FIG. 3 schematically depicts a simplified flow chart according to some embodiments,

FIG. 4 flow chart according to some embodiments,

FIG. 5 schematically depicts a simplified flow chart according to some embodiments,

FIG. 6 schematically depicts a simplified flow chart according to some embodiments,

FIG. 7 schematically depicts a simplified flow chart according to some embodiments,

FIG. 8 schematically depicts a simplified flow chart according to some embodiments,

FIG. 9 schematically depicts a simplified flow chart according to some embodiments,

FIG. 10 schematically depicts a simplified flow chart according to some embodiments,

FIG. 11 schematically depicts a diagram according to some embodiments,

FIG. 12 schematically depicts a diagram according to some embodiments,

FIG. 13 schematically depicts a diagram according to some embodiments, and

FIG. 14 schematically depicts a simplified block diagram of an apparatus according to some embodiments.

### DESCRIPTION OF SOME EXEMPLARY EMBODIMENTS

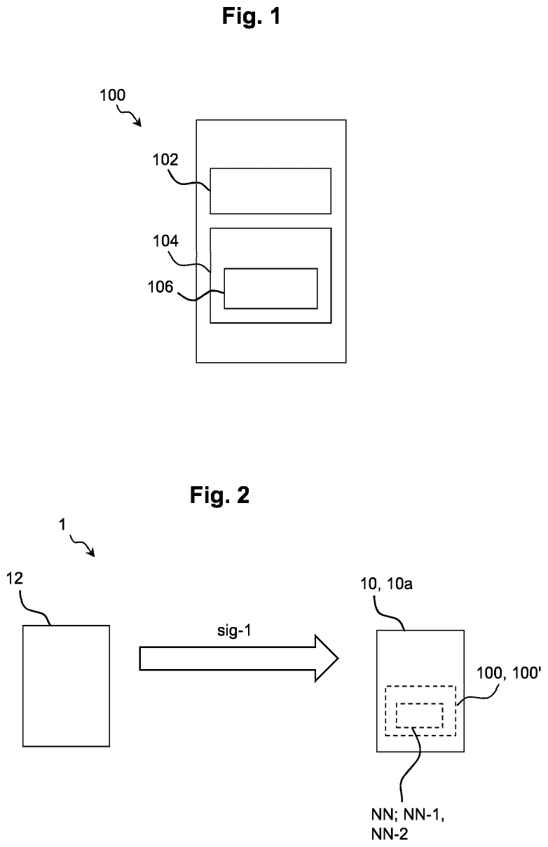

Some embodiments, see FIGS. 1, 2, and 3, relate to an apparatus 100, comprising at least one processor 102, and at least one memory 104 storing instructions 106, the at least one memory 104 and the instructions 106 configured to, with the at least one processor 102, cause a receiver (FIG. 2) to perform 204 (FIG. 3) a correlation processing of a first signal sig-1 received by the receiver and/or of a second signal sig-2 which can be derived from the first signal sig-1, and to at least temporarily modify 206 an output signal cp-out of the correlation processing 204 using at least one neural network NN; NN-1, NN-2, wherein a modified output signal cp-out′ may be obtained.

In some embodiments, at least temporarily modifying 206 an output signal cp-out of the correlation processing 204 using at least one neural network NN; NN-1, NN-2 may enable to improve signal to noise ratio (SNR) values, e.g. by providing a coherent combining of input signals sig-1, which may be beneficial for a detection of a physical random access channel, PRACH.

In some embodiments, the coherent combining may be enabled by the at least one neural network NN; NN-1, NN-2 learning channel coefficients of a radio channel associated with the first signal sig-1 and using the learned, e.g. trained, channel coefficients for enabling coherent combining.

In other words, in some embodiments, conventional, e.g. PRACH, detection schemes may be enhanced by exemplary embodiments, e.g. by adding machine-learning backed coherent antenna combining gains.

In some embodiments, a procedure to obtain the gains may comprise at least one neural-network (NN), e.g. an artificial neural network (ANN), e.g. a deep neural network (DNN), which may learn channel coefficients associated with a radio channel over which the received signal sig-1 has been transmitted and which may use the learned channel coefficients e.g. to produce a coherent combining of the input signals (e.g., the received signal), e.g. to enhance SNR values, for example at least in some embodiments at least sometimes beyond non-coherent conventional combining approaches.

In some embodiments, the enhanced combining scheme according to some embodiments may be used in situations where an SNR of the received signal sig-1 is below a predetermined threshold. In some embodiments, for example, when the SNR of the received signal sig-1 is equal to or greater than the predetermined threshold, another scheme, for example a conventional PRACH detection scheme, may be used.

In some embodiments, the apparatus 100 (FIG. 1, 2) may be for a receiver 10, for example for a base station 10a, e.g. a gNodeB (gNB), e.g. for the wireless communications system 1.

In some embodiments, the apparatus 100 may be integrated in the receiver 10 and/or gNB 10a.

In some embodiments, the apparatus 100 according to the embodiments or its functionality, respectively, may be used for or within wireless communications systems 1, e.g. networks, based on or at least partially adhering to third generation partnership project, 3GPP, radio standards such as 5G (fifth generation), e.g. 5G NR (new radio), or other radio access technology.

In some embodiments, the first signal sig-1 may comprise a preamble, for example PRACH preamble, of a UE 12 trying to access a radio cell served by the gNB 10.

In some embodiments, the instructions 106 (FIG. 1), when executed by the at least one processor 102, cause the receiver 10 to determine 208 at least one random access preamble identifier RAPID based on at least one of a) the output signal cp-out of the correlation processing 204 and b) the modified output signal cp-out′ of the correlation processing 204.

In other words, in some embodiments, at least sometimes, the random access preamble identifier RAPID may be detected, see block 208, using both the output signal cp-out of the correlation processing and the modified output signal cp-out′ of the correlation processing. In some embodiments, it is also conceivable to at least sometimes detect the random access preamble identifier RAPID based on the modified output signal cp-out′ of the correlation processing. In some embodiments, it is also conceivable to at least sometimes detect the random access preamble identifier RAPID based on the (non-modified) output signal cp-out of the correlation processing.

In some embodiments, the correlation processing 204 may comprise a correlation of the received signal sig-1 and/or of the signal sig-2 derived from the received signal sig-1, with a physical root sequence which may in some embodiments be configured in a radio cell provided by the gNB 10a.

In some embodiments, the correlation processing 204 may be performed in the frequency domain. In some embodiments, a correlation processing 204 in the frequency domain may be equivalent to a correlation of a corresponding time domain signal with, for example all, time-domain cyclic shifted versions of the root sequence.

In some embodiments, an advantage of performing the correlation processing 204 in the frequency domain is that only one multiplication per physical root is required. In some embodiments, the correlation processing 204 may be performed and/or repeated for several, e.g. all, physical root sequences, which are e.g. configured in a respective cell, e.g. as provided by the gNB.

In some embodiments, the second signal sig-2, which can be derived from the first signal sig-1, may e.g. be derived from the first signal sig-1 by using one or more of the following optional aspects A), B), C), D), E), which are exemplarily collectively symbolized by block 202 of FIG. 3:
A) The receiver 10, e.g. gNB 10a, may receive the first signal sig-1 at its antennas, also see block 200 of FIG. 3, the first signal sig-1 for example comprising a random access preamble transmitted by a UE 12 (FIG. 2),
B) the receiver 10 may conduct one or more pre-processing procedures 202, e.g. prior to preamble detection 208, such as e.g. down-conversion (e.g., transforming the first signal sig-1 to a lower frequency range such as a low-pass frequency range or an intermediate frequency range), (e.g. band-pass)-filtering, analog-to-digital conversion,
C) Removal of a preamble cyclic-prefix (CP). In some embodiments, various preamble formats showing different CP are defined in standards, e.g. to support different coverage ranges from few hundreds of meters up to more than 100 kilometers,
D) Coherent combining over symbol repetitions in time domain per antenna. Whether or not coherent combining over repetitions is employed in some embodiments depends on a selected combining strategy.
E) Conversion of the time domain signal, e.g. as obtained according to at least one of the preceding aspects A), B), C), D) into the frequency domain, for example via a FFT (Fast Fourier Transform). The size of a so obtained complex-valued frequency domain signal per antenna in some embodiments has a same size as the sequence length.

In some embodiments, one or more, or all, of the preceding aspects A), B), C), D), E) may be performed, and the frequency domain signal as obtained according to exemplary aspect E) may be used as the second signal sig-2, e.g. as an input signal to the correlation processing 204 (FIG. 3).

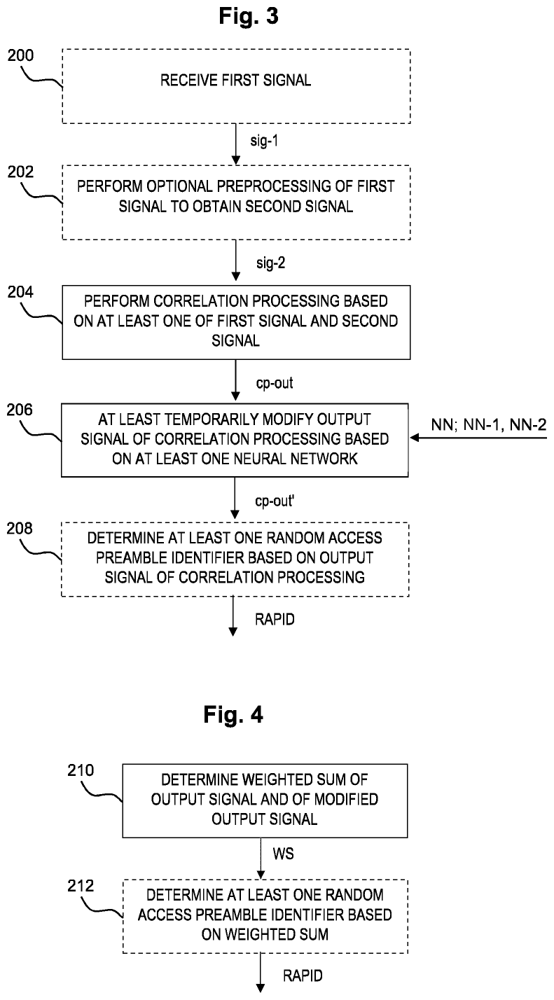

In some embodiments, FIG. 4, the instructions 106 (FIG. 1), when executed by the at least one processor 102, cause the receiver 10 to determine 210 (FIG. 4) a weighted sum WS of the output signal cp-out of the correlation processing 204 and of the modified output signal cp-out′ of the correlation processing 204, which may increase operational flexibility in some embodiments. Optional block 212 of FIG. 4 symbolizes a determination of at least random access preamble identifier RAPID based on the weighted sum WS.

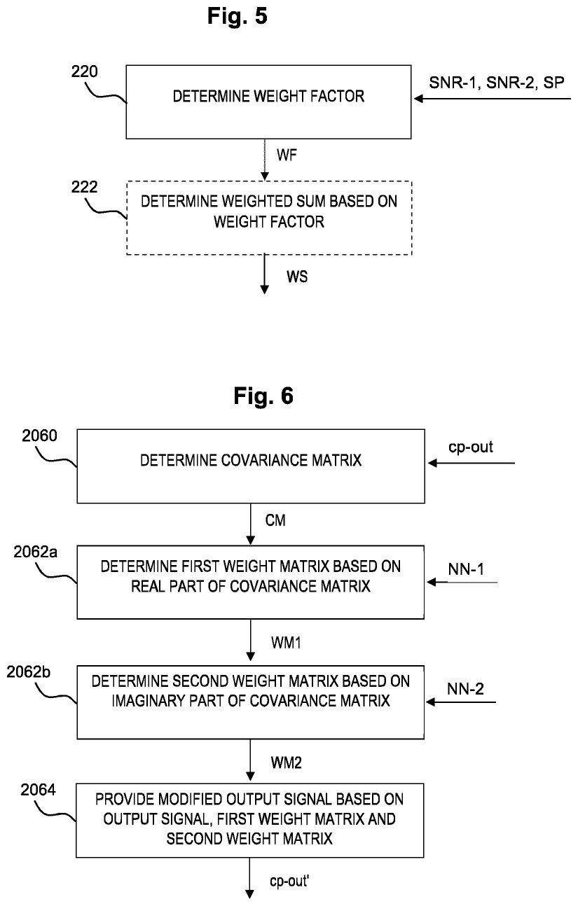

In some embodiments, FIG. 5, the instructions 106, when executed by the at least one processor 102, cause the receiver 10 to determine 220 a weight factor WF for determining 222 the weighted sum WS.

In some embodiments, the instructions 106, when executed by the at least one processor 102, cause the receiver 10 to determine 220 the weight factor WF based on at least one of the following elements: a) a first signal to noise ratio SNR-1 characterizing an estimated signal to noise ratio of the output signal cp-out of the correlation processing 204, b) a second signal to noise ratio SNR-2 for which the weight factor WF equals 0.5, c) a predetermined slope parameter SP, which for example characterizes a sensitivity of the weight factor WF with respect to the first signal to noise ratio SNR-1.

In some embodiments, the instructions 106, when executed by the at least one processor 102, cause the receiver 10 to determine 220 the weight factor WF based on the equation:

$$α = \frac{1}{1 + {e}^{( {SNR}_{est} - {SNR}_{trans} ) / Slope}} ,$$

wherein α characterizes the weight factor WF, wherein SNRₑₛₜ characterizes the first signal to noise ratio SNR-1, wherein SNRₜᵣₐₙₛ characterizes the second signal to noise ratio SNR-2, wherein Slope characterizes the slope parameter SP, and wherein e^{(•)} characterizes the exponential function.

In some embodiments, if z is a single complex value, e.g. sample over N many receive antenna ports (not shown) of the receiver 10 and one subcarrier (i.e. z is a complex vector of dimension 1×N) e.g. as output by block 204 (e.g. correlation processing, e.g. using a matched filter technique) and ƒ(z) denotes an output of the at least one neural network NN; NN-1, NN-2, e.g. the modified output cp-out′, and α is the weight factor, e.g. in the range [0,1], then an output ZÅC^{1×N} of the block 206 can be described as:

Z=(1−a)·z+a·ƒ(z)

Thus, in some embodiments, the slope parameter SP may be used to control “how fast” the processing “switches” from a primarily neural-network controlled processing (weight factor α e.g. close to 1, e.g. at low SNR, to a strongly bypassed signal, weight factor α e.g. close to 0, e.g. at high SNR.

In some embodiments, scalar weight factor α depends on the signal SNR value SNRₑₛₜ as mentioned above and on the preamble format.

In some embodiments, the sigmoid function is an appropriate choice for the weight factor WF, but in some other embodiments, another function like tanh may also a suitable choice.

In some embodiments, using the weight factor and e.g. the weighted sum combination as explained above, also see block 210 of FIG. 4, enables to benefit from the neural network's performance at low SNR, while e.g. ensuring a performance at higher SNRs as well, e.g. by using a conventional setup (e.g., characterized by weight factor WF close to zero).

In some embodiments, FIG. 3, 6, at least temporarily modifying 206 the output signal cp-out of the correlation processing 204 comprises: determining 2060 (FIG. 6) a covariance matrix CM based on the output signal cp-out of the correlation processing 204, determining 2062a a first weight matrix WM1 based on a real part of the covariance matrix CM using a first neural network NN-1, determining 2062b a second weight matrix WM2 based on an imaginary part of the covariance matrix CM using a second neural network NN-2, providing 2064 the modified output signal cp-out′ based on the output signal cp-out of the correlation processing 204, the first weight matrix WM1, and the second weight matrix WM2.

In some embodiments, providing 2064 the modified output signal cp-out′ comprises: providing the modified output signal based on the equation f(z)=X+iY, wherein f(z) characterizes the modified output signal cp-out′, wherein z characterizes the output signal cp-out of the correlation processing 204 (FIG. 3), wherein X=Wr·Re(z)−Wi·Im(z), wherein Y=Wr·Im(z)+Wi·Re(z), wherein Wr characterizes the first weight matrix WM1, wherein Wi characterizes the second weight matrix WM2, wherein Re(•) characterizes the real part, and wherein Im(•) characterizes the imaginary part.

In some embodiments, providing 2064 the modified output signal cp-out′ is performed for one or more subcarriers and/or one or more root sequences associated with the first signal sig-1 (FIG. 2).

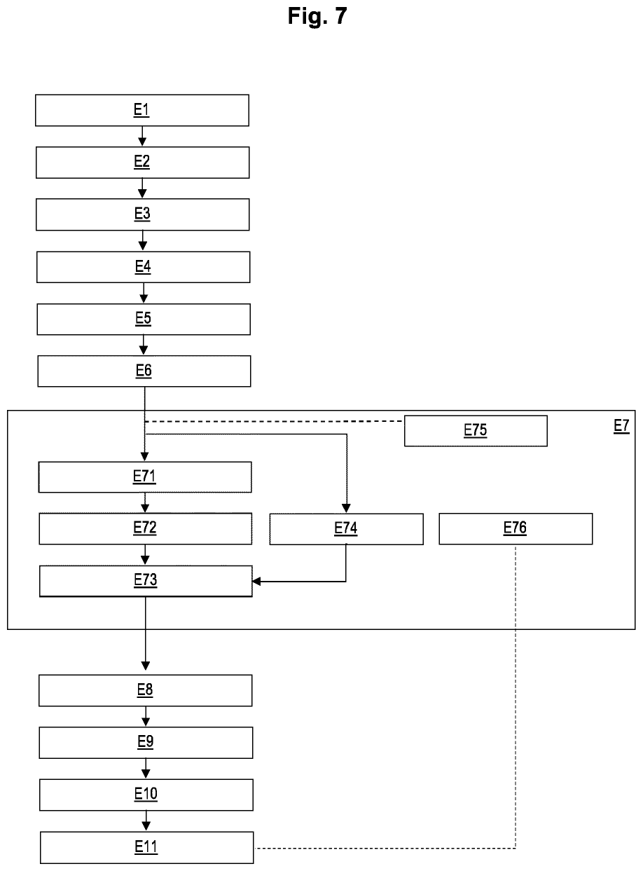

FIG. 7 schematically depicts a simplified flow chart according to some embodiments. Block E1 symbolizes a reception of the first signal sig-1 at receive antennas of the receiver 10 (FIG. 2), block E2 symbolizes an optional baseband signal processing according to some embodiments, block E3 symbolizes an optional cyclic prefix removal according to some embodiments, block E4 symbolizes a coherent combination over symbol repetitions in the time domain per antenna according to some embodiments. Block E5 symbolizes an FFT for transforming the output of block E4 into the frequency domain. Block E6 symbolizes a correlation processing, e.g. using a matched filter-based approach, for example a correlation of the input signal to block E6 with a physical root sequence configured in a cell in the frequency domain.

Block E7 symbolizes the modification 206 (FIG. 3) according to some embodiments, wherein block E71 symbolizes a neural network-based processing, block E72 symbolizes weighting, e.g. multiplication, of an output of block E71 with the weight factor a, block E73 symbolizes an addition of the output of block E72 with an output of the block E6 (e.g., similar to signal cp-out of FIG. 3) weighted, e.g. multiplied by a value of (1−α), see block E74, and block E75 symbolizes an SNR estimation which may e.g. be used to determine a value of the weight factor α as explained above, e.g. with respect to FIG. 5.

Block E76 symbolizes an optional detection threshold lookup table which in some embodiments may store and/or provide appropriate detection thresholds e.g. as a function of the (first) SNR SNR-1, e.g. to block E11, which in some embodiments may comprise a preamble signature and/or timing advance estimation stage. In some embodiments, the appropriate detection thresholds can be determined during a training process of the at least one neural network NN; NN-1, NN-2.

In some embodiments, at least one of the following exemplary aspects may be used, e.g. based on the modified output signal of the correlation processing, i.e. using the modified output signal of the correlation processing, e.g. the output of block E73 of FIG. 7, according to some embodiments as input:
a) transforming the modified output cp-out′ signal into the time domain, e.g. for a plurality or all correlated signals, e.g. by block E8 of FIG. 7,
b) determining, e.g. calculating, a squared norm, e.g. for the, e.g. for each, time domain signal(s) as obtained by preceding aspect a), e.g. by block E9,
c) summation of signals, e.g. as obtained by preceding aspect b) (block E9), e.g. over all receive antennas of the receiver 10, wherein e.g. one power-delay profile per physical root sequence may be obtained, see block E10,
d) determining, see block E11, at least one, e.g. all, random access preamble identifier(s) (RAPID) and/or timing advance value(s), e.g. based on the power delay profiles as obtained by preceding aspect c) (block E10).

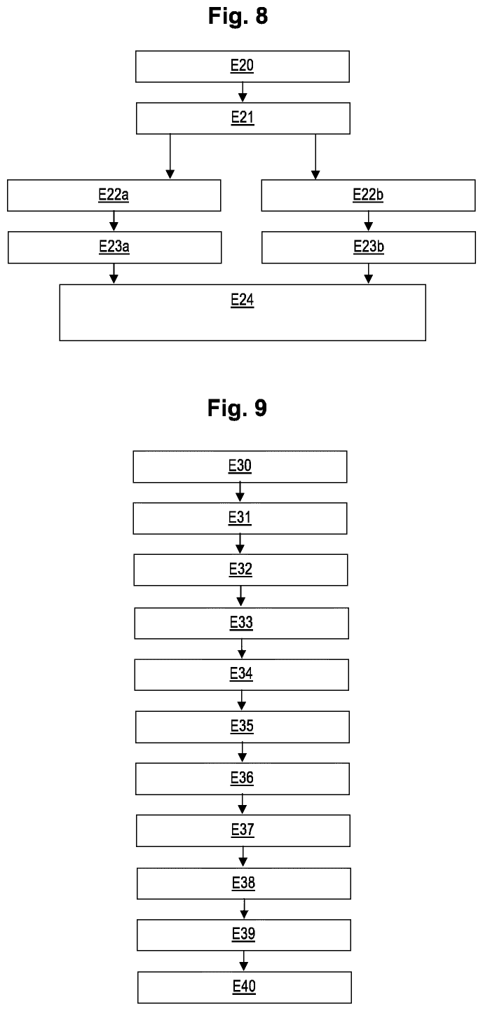

FIG. 8 schematically depicts a simplified flow chart according to some embodiments. In some embodiments, the depicted structure may be used to implement the modifying block 206 of FIG. 3. Block E20 symbolizes an input signal which may e.g. be characterized by a complex vector z=x+iy, wherein is the imaginary unit. Block E21 symbolizes the covariance matrix Cov=z^{T}*z, e.g. similar to reference sign CM of FIG. 6. Block E22a of FIG. 8 symbolizes the real part of the covariance matrix E21, and block E22b symbolizes the imaginary part of the covariance matrix E21.

Block E23a symbolizes a first neural network NN-1 transforming the real part E22a of the covariance matrix E21 into a first weight matrix WM1, and block E23b symbolizes a second neural network NN-2 transforming the imaginary part E22b of the covariance matrix E21 into a second weight matrix WM2.

Block E24 symbolizes a determination of the modified output signal cp-out′ (FIG. 3) based on the weighting matrices WM1, WM2 and the input signal E20, e.g. based on the equation Y=Wr·Im(z)+Wi·Re(z) as explained above.

In some embodiments, instead of two neural networks NN-1, NN-2 or E23a, E23b, respectively, a single neural network NN may be used, which may combine the functionality of the two neural networks NN-1, NN-2.

In some embodiments, the at least one neural network NN, NN-1, NN-2 comprises two or more, for example four, fully connected layers with a number n of processing elements each, wherein n may depend on a number N of receive antenna ports over which the first signal sig-1 is received, wherein for example n>N, or n>=N².

In some embodiments, the at least one neural network NN, NN-1, NN-2 comprises two or more, for example four, fully connected layers with N² many processing elements each.

In some embodiments, the at least one neural network NN, NN-1, NN-2 may be a convolutional neural network, CNN, of 1 or 2 or three dimensions.

In some embodiments, the at least one neural network NN, NN-1, NN-2 is configured to modify noise-related statistics of the output signal cp-out of the correlation processing 204.

FIG. 9 schematically depicts a simplified flow chart according to some embodiments, which symbolizes an exemplary processing sequence as may e.g. be provided by at least one of the neural networks NN, NN-1, NN-2, e.g. for determining the weight matrices WM1, WM2.

Block E30 symbolizes an input e.g. comprising the real part of the covariance matrix CM discussed above or the imaginary part of the covariance matrix CM. In some embodiments, the input has a dimension (N, N), i.e. N many rows and N many columns.

Block E31 symbolizes a flatten processing which reduces the number of dimensions, e.g. from two to one, resulting in a vector of size N². Next, the vector is passed through a stack of fully connected layers E32, E35, E36, E38 each of which comprises corresponding Rectifier Linear Units (ReLU) E33, E35, E37 to provide nonlinearity. Block E39 symbolizes a reshaping processing wherein the respective N×N matrix WM1 or WM2 (depending on the input) is obtained from the output of block E38 which comprises the abovementioned vector of size N².

In some embodiments, other than the presently depicted processing structures or sequence of FIG. 9 may be used, e.g. to implement the neural networks NN-1, NN-2.

In some embodiments, more than four fully connected layers E32, E34, E36, E38 may be provided.

In some embodiments, one or more dropout layers (not shown) may be provided, for example in a training phase. In some embodiments, the one or more dropout layers may be omitted, e.g. if the training is completed.

In some embodiments, other activation layers than the exemplarily mentioned ReLU-type layers E33, E35, E37 may be used.

In some embodiments, the neural-network processing exemplarily depicted by FIG. 9 may modify the statistics on noise of the input data or signal E30.

In some embodiments, e.g. to maintain a high preamble detection performance over a wide range of SNR values, a table may be provided which may e.g. store and/or deliver appropriate detection thresholds as function of SNR to the preamble signature and timing advance estimation stage (block E11 of FIG. 7). In some embodiments, the appropriate threshold values can be determined during a training process.

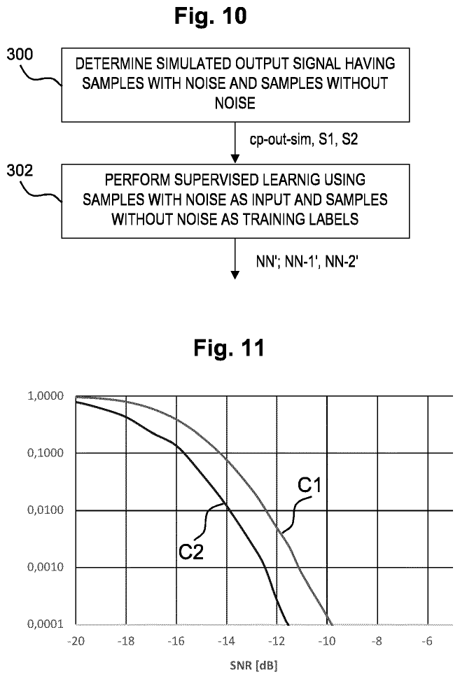

Some embodiments, FIG. 10, relate to a method of training a neural network NN, NN-1, NN-2, e.g. a neural network NN, NN-1, NN-2 for an apparatus 100 (FIG. 1) according to exemplary embodiments, the method comprising: Determining 300 (FIG. 10) a simulated output signal cp-out-sim of a correlation processing 204 (FIG. 3) of a first signal sig-1 (and/or of a second signal sig-2 that may be derived from the first signal sig-1) comprising first samples Si with noise and second samples S2 without noise, performing 302 supervised training of the neural network NN, NN-1, NN-2 using the samples S1 with noise as input for the neural network and the samples S2 without noise as training labels. As a result, a correspondingly trained neural network NN′, NN-1′, NN-2′ is obtained.

In some embodiments, the neural network NN, NN-1, NN-2 is designed and/or trained to learn an effect of different spatial channels associated with the received signal sig-1, and to equalize it such that spatial coherent combining can, for example at least to some extent, be attained.

In some embodiments, the neural network NN, NN-1, NN-2 is designed and/or trained to perform a blind channel estimation and/or equalization.

In some embodiments, a mean squared error between neural-network processed samples and noise-free samples may be used as optimization criterion, e.g. during a parameter optimization according to some embodiments.

In some embodiments, the at least one neural network NN, NN-1, NN-2 is not trained for different logical root indices. Therefore, in some embodiments, for example only samples with a logical root index equal 0 may be used for training.

In some embodiments, training data originating from one of a plurality of sectors of a radio cell in deployment may be used.

In some embodiments, samples used for the training may cover a SNR range between −14 dB and 0 dB, e.g. with a step size of 1 dB. In some embodiments, a number of samples per SNR is around 1.5 million.

Some embodiments relate to a wireless communications system 1 (FIG. 2) comprising at least one apparatus 100 according to the embodiments.

In the following, an exemplary evaluation of aspects of some embodiments are provided.

In some embodiments, a preamble detection performance of the method according to the embodiments has been compared against a conventional detection scheme by means of link-level simulations. First, information on the deployment scenario and on the used PRACH format is provided. Then, a structure, training and inference of the detector according to some exemplary embodiments is described. Finally, exemplary information on observed key-performance indicators is provided.

In some embodiments, related to a wireless network scenario and PRACH format, as exemplary deployment it has been selected an urban macro scenario (for example according to 3GPP UMa according to TR 38.900) with 8 km cell radius and single tri-sectorized base station. The number N of receive antennas per sector was 8 in a vertical arrangement. In order to limit numerical effort, in some embodiments, an off-standard PRACH format as follows was used:

| L_{RA} | Δf^{RA} | Nᵤ | N_{CP}^{RA} |
|---|---|---|---|
| 139 | 15 kHz | 1 · 2048 · 64 | 2048 · 64 |

In some embodiments, an exemplary neural network structure as follows has been used for exemplary evaluation, also see the exemplary embodiment discussed above with respect to FIG. 9.

| | | | Number |
|---|---|---|---|
| | Input | Output | of Trainable |
| Type | Size | Size | Parameters |
| Flatten | 8 × 8 | 64 × 1 | 0 |
| Fully-Connected Layer | 64 × 1 | 64 × 1 | 4160 = 64*64 + 64 |
| Rectifier Unit | 64 × 1 | 64 × 1 | 0 |
| Fully-Connected Layer | 64 × 1 | 32 × 1 | 2080 = 64*32 + 32 |
| Rectifier Unit | 32 × 1 | 32 × 1 | 0 |
| Fully-Connected Layer | 32 × 1 | 32 × 1 | 1056 = 32*32 + 32 |
| Rectifier Unit | 32 × 1 | 32 × 1 | 0 |
| Fully-Connected Layer | 32 × 1 | 64 × 1 | 2112 = 32*64 + 64 |
| Reshape | 64 × 1 | 8 × 8 | 0 |
| Total | | | 9408 |
| Total real + complex | | | 18816 = 2*9408 |

From the table summary we observe that the total number of used parameters is 18816.

It is emphasized that in some embodiments only one parameterized neural network may be used, i.e. there is no explicit dependency on a number of configured logical root sequence indices in a sector.

In some embodiments, a performance validation comprises use of a link-level simulation tool with a trained neural network in inference mode, e.g. to obtain preamble detection performance figures. In some embodiments, all three sectors in the deployment contributed in the validation process. In addition, in some embodiments, all 138 possible logical root indices for a 139 long Zadoff-Chu sequence were considered. Missed detections, false alarms and timing advance estimation errors served as exemplary key performance metrices.

### Performance Results

FIG. 11 schematically depicts a probability of missed detections as a function of SNR. Curve C1 symbolizes the results for a conventional technique, while curve C2 symbolizes the results for the method according to exemplary embodiments. As an example, at a probability of missed detection, a link-budget improvement by 1.5 dB of curve C2 over curve C1 can be observed.

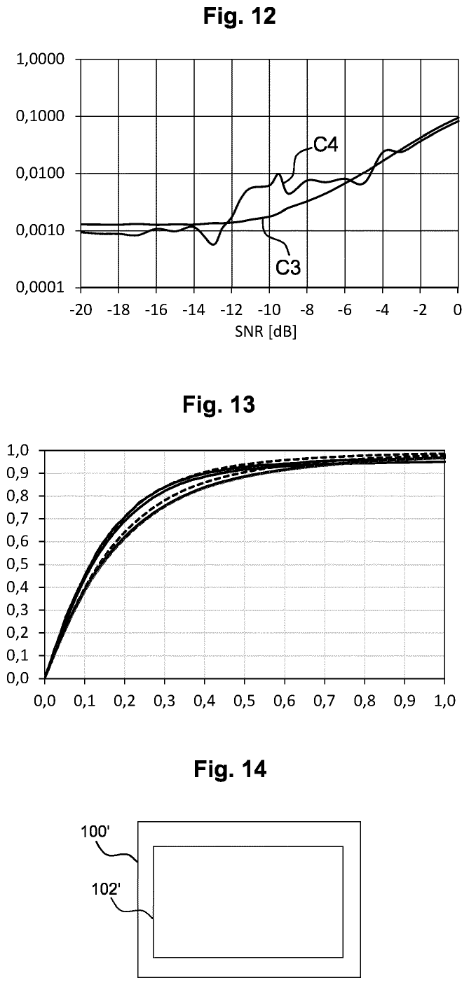

In contrast to missed detections, a small impact of the detection scheme according to exemplary embodiments on false alarms and timing advance estimation errors can be observed as shown in FIG. 12, 13.

In FIG. 12, curve C3 symbolizes a false alarm probability of conventional approaches, whereas curve C4 symbolizes the false alarm probability of the approach based on exemplary embodiments.

In FIG. 13, a cumulative distribution function, CDF, over a timing advance estimation error is depicted as a function of SNR, wherein solid lines symbolize conventional approaches, and dashed lines symbolize approaches according to exemplary embodiments.

Further exemplary embodiments, FIG. 14, relate to an apparatus 100′ comprising means 102′ for causing a receiver (FIG. 2) to perform a correlation processing 204 of a first signal sig-1 received by the receiver 10 and/or of a second signal sig-2 which can be derived from the first signal sig-1, and to at least temporarily modify 206 an output signal cp-out of the correlation processing 204 using at least one neural network NN, NN-1, NN-2, wherein a modified output signal cp-out′ may be obtained. In some embodiments, the means 102′ for causing the receiver to e.g. perform the correlation processing may comprise at least one processor 102 (FIG. 1), and at least one memory 104 storing instructions 106, the at least one memory 104 and the instructions 106 configured to, with the at least one processor 102, cause a receiver 10 to perform the correlation processing 204 and/or other aspects of the method according to the embodiments exemplarily disclosed above.

Some exemplary embodiments, FIG. 3, relate to a method of operating a receiver 10, the method comprising: performing 204 a correlation processing of a first signal sig-1 received by the receiver 10 and/or of a second signal sig-2 which can be derived from the first signal sig-1, and at least temporarily modifying 206 an output signal of the correlation processing using at least one neural network, wherein a modified output signal may be obtained.

While in some conventional PRACH detection algorithms, at the cell-edge, deep-fade condition or blockage, i.e. when the signal-to-noise ratio is very low, the detection probability may be very low, the approach based on exemplary embodiments may lead to an increased detectability even at comparatively low SNR at the receiver (e.g. gNB 10a) of a random access preamble transmitted by a user terminal.

Using exemplary embodiments, a behavior or operation of a (PRACH) preamble detector may e.g. be designed such that the functionality provided by the neural network NN, NN-1, NN-2, e.g. modification 206, is dominant, e.g. in a low SNR regime, whereas, in some embodiments, in a high SNR regime, a detection may almost solely be based on conventional schemes.

In some embodiments, the proposed solution may guarantee that the performance is better or equal to a conventional approach.

In the following, some further aspects and advantages of exemplary embodiments are listed.
a) Using domain knowledge: in some embodiments, matched filtering may be used, therefore it is not required to re-learn or re-train PRACH sequences or to train for all the different sequences,
b) Coherent combining: In some embodiments, it is implicitly tried to perform a blind channel estimation and/or equalization,
c) Ensuring greater-than-or-equal performance: Some embodiments can guarantee that the performance is never worse than that of conventional approaches. In some embodiments, this may be of particular importance as usually a performance of competitive schemes is only statistically or on average better than conventional approaches,
d) low complexity.

1. A receiver comprising at least one processor and at least one memory storing instructions, the at least one memory and the instructions configured to, with the at least one processor, cause the receiver to:
perform a correlation processing of a first signal received by the receiver and/or of a second signal which is derived from the first signal, and
at least temporarily modify an output signal of the correlation processing using at least one neural network of the receiver to generate a modified output signal.

2. The receiver according to claim 1, wherein the instructions, when executed by the at least one processor, cause the receiver to determine at least one random access preamble identifier based on at least one of a) the output signal of the correlation processing and b) the modified output signal of the correlation processing.

3. The receiver according to claim 1, wherein the instructions, when executed by the at least one processor, cause the receiver to determine a weighted sum of the output signal of the correlation processing and of the modified output signal of the correlation processing.

4. The receiver according to claim 3, wherein the instructions, when executed by the at least one processor, cause the receiver to determine a weight factor for determining the weighted sum.

5. The according to claim 4, wherein the instructions, when executed by the at least one processor, cause the receiver to determine the weight factor based on at least one of the following elements: a) a first signal to noise ratio characterizing an estimated signal to noise ratio of the output signal of the correlation processing, b) a second signal to noise ratio for which the weight factor equals 0.5, c) a predetermined slope parameter, which characterizes a sensitivity of the weight factor with respect to the first signal to noise ratio, wherein the instructions, when executed by the at least one processor, cause the receiver to determine the weight factor based on the equation:
$$α = \frac{1}{1 + {e}^{( S N {R}_{est} - S N {R}_{trans} ) / Slope}} ,$$
wherein α characterizes the weight factor, wherein SNRₑₛₜcharacterizes the first signal to noise ratio (SNR-1), wherein SNRₜᵣₐₙₛ characterizes the second signal to noise ratio, wherein Slope characterizes the slope parameter, and wherein e^{(•)} characterizes the exponential function.

6. The receiver according to claim 1, wherein at least temporarily modifying the output signal of the correlation processing comprises:
determining a covariance matrix based on the output signal of the correlation processing,
determining a first weight matrix based on a real part of the covariance matrix using a first neural network of the at least one neural network,
determining a second weight matrix based on an imaginary part of the covariance matrix using a second neural network of the at least one neural network,
providing the modified output signal based on the output signal of the correlation processing, the first weight matrix, and the second weight matrix.

7. The receiver according to claim 6, wherein providing the modified output signal comprises:
providing the modified output signal based on the equation f(z)=X+iY, wherein f(z) characterizes the modified output signal, wherein z characterizes the output signal of the correlation processing, wherein X=Wr·Re(z)−Wi·Im(z), wherein Y=Wr·Im(z)+Wi·Re (z), wherein Wr characterizes the first weight matrix, wherein Wi characterizes the second weight matrix, wherein Re(z) characterizes the real part of z, and wherein Im(z) characterizes the imaginary part of z.

8. The receiver according to claim 6, wherein providing the modified output signal is performed for one or more subcarriers and/or one or more root sequences associated with the first signal.

9. The receiver according to claim 1, wherein the at least one neural network comprises two or more fully connected layers with a number n of processing elements each, wherein n depends on a number N of receive antenna ports over which the first signal is received, wherein n>N or n>=N².

10. The receiver according to claim 1, wherein the at least one neural network is configured to modify noise-related statistics of the output signal of the correlation processing.

11. (canceled)

12. A method of operating a receiver, the method comprising the receiver:
performing a correlation processing of a first signal received by the receiver and/or of a second signal which is derived from the first signal, and
at least temporarily modifying an output signal of the correlation processing using at least one neural network to generate a modified output signal.

13. A method of training a neural network for the receiver according to claim 1, the method comprising the receiver:
determining a simulated output signal of a correlation processing of a first signal comprising first samples with noise and second samples without noise,
performing supervised training of the neural network using the samples with noise as input for the neural network and the samples without noise as training labels, wherein the neural network is designed and/or trained to learn an effect of different spatial channels associated with the received signal.

14. A wireless communications system comprising at least one receiver according to claim 1.

15. A non-transitory computer readable medium comprising program instructions for causing a receiver to perform the method of claim 12.

16. A non-transitory computer readable medium comprising program instructions for causing a receiver to perform the method of claim 13.
